(19) United States
(12) Patent Application Publication
(10) Pub. No.: US 2025/0016052 A1
(43) Pub. Date: Jan. 9, 2025

(54) METHOD, DEVICE AND COMPUTER PROGRAM PRODUCT FOR WIRELESS COMMUNICATION

(71) Applicant: ZTE Corporation, Shenzhen (CN)

(72) Inventors: Lin CHEN, Shenzhen (CN); Mengzhen WANG, Shenzhen (CN); Weiqiang DU, Shenzhen (CN); Wanfu XU, Shenzhen (CN); Tao QI, Shenzhen (CN)

(21) Appl. No.: 18/891,505

(22) Filed: Sep. 20, 2024

Related U.S. Application Data
(63) Continuation of application No. PCT/CN2022/093689, filed on May 18, 2022.

(51) Int. Cl. H04L 41/084

(52) U.S. Cl. CPC H04L 41/084

(57) ABSTRACT

Method, device and computer program product for wireless communication are provided. A method includes: receiving, by a first wireless communication terminal from a wireless communication node, an aggregation configuration; and performing, by the first wireless communication terminal, the aggregation configuration.

### CROSS REFERENCE TO RELATED APPLICATIONS

This application is a continuation of International Patent Application No. PCT/CN2022/093689, filed on May 18, 2022, the disclosure of which is incorporated herein by reference in its entirety.

### TECHNICAL FIELD

This document is directed generally to wireless communications, in particular to 5^{th} generation (5G) wireless communication.

### BACKGROUND

With the development of wireless multimedia services, demands of high data rate services significantly increase. Under such a condition, requirements of system capacity and coverage of conventional cellular network become higher. Besides, due to application scenarios of public safety, social network, short distance data sharing, local advertisement, etc., demands of proximity services which allow people to acknowledge or to communicate with adjacent people or objects also increase. However, the conventional cellular network has limitations with regard to supporting the high data rate services and the proximity services. As a result, device-to-device (D2D) communication technology is proposed to serve such demands. By adopting the D2D technology, burden of the cellular network can be decreased, power consumption of user equipment can be reduced, data rate can be increased and robustness of network infrastructures can be improved, so as to fulfill the demands of the high data rate services and the proximity services. The D2D technology is also called the proximity service (ProSe) or sidelink communications and an interface between equipment is known as PC5 interface.

### SUMMARY

The present disclosure relates to methods, devices, and computer program products for wireless communication corresponding to user equipment (UE) aggregation.

One aspect of the present disclosure relates to a wireless communication method. In an embodiment, the wireless communication method includes: receiving, by a first wireless communication terminal from a wireless communication node, an aggregation configuration; and performing, by the first wireless communication terminal, the aggregation configuration.

Another aspect of the present disclosure relates to a wireless communication method. In an embodiment, the wireless communication method includes: receiving, by a wireless communication node from a core network, terminal aggregation information; and performing, by the wireless communication node, an aggregation configuration.

Another aspect of the present disclosure relates to a wireless communication terminal. In an embodiment, the wireless communication terminal includes a communication unit and a processor. The processor is configured to: receive, from a wireless communication node, an aggregation configuration; and perform the aggregation configuration.

Another aspect of the present disclosure relates to a wireless communication node. In an embodiment, the wireless communication node includes a communication unit and a processor. The processor is configured to: receive, from a core network, terminal aggregation information; and perform an aggregation configuration.

Various embodiments may preferably implement the following features:

Preferably, the aggregation configuration comprises at least one of:
an aggregation index;
one or more terminal identifiers, IDs, for aggregation;
an aggregation mode;
a bearer mapping configuration;
a configuration for at least one of data duplication or data split;
a path indication;
aggregation assistance information to be used by aggregated terminals; or
aggregation criteria.

Preferably, the terminal ID can be at least one of the following:
a Cell Radio Network Temporary Identifier, C-RNTI,
a System Architecture Evolution Temporary Mobile Subscriber Identity, S-TMSI, or
an aggregation ID received from the wireless communication node.

Preferably, the aggregation mode configuration comprises at least one of:
a radio bearer, RB, level aggregation;
a Dual Active Protocol Stack, DAPS, like aggregation; or
a Radio Link Control, RLC, channel level aggregation.

Preferably, the bearer mapping configuration comprises at least one of:
a mapping between a Radio Bearer, RB, of the first wireless communication terminal and an RB of the first or a second wireless communication terminal;
a mapping between a Radio Bearer, RB, of the first wireless communication terminal and a terminal ID for aggregation of the first or second wireless communication terminal;
a mapping between a QoS Flow Identifier, QFI, of the first wireless communication terminal and a Radio Bearer, RB, of the first or second wireless communication terminal; or
a mapping between a QoS Flow Identifier, QFI, of the first wireless communication terminal and a terminal ID for aggregation of the first or second wireless communication terminal.

Preferably, the bearer mapping configuration comprises a mapping between an RB of the first wireless communication terminal and a Uu RLC channel of a second wireless communication terminal, wherein the Uu RLC channel of the second wireless communication terminal is identified by a terminal ID, a Logical Channel ID, LCID or an RLC channel ID.

Preferably, the bearer mapping configuration comprises at least one of:
an indication indicating the first or second wireless communication terminal allocating a common Packet Data Convergence Protocol, PDCP, sequence number, SN;
an indication indicating the first or second wireless communication terminal responsible for PDCP reordering and discard functions;
an RB of the first or second wireless communication terminal of the common PDCP entity which allocates the PDCP SN;
an RB of the first or second wireless communication terminal of the common PDCP entity which is responsible for PDCP reordering and discard functions; or
an RB of the first or second wireless communication terminals participating in the PDCP encryption or decryption, compression or de-compression processing.

Preferably, the RB of the first or second wireless communication terminal is identified via the RB ID and or the terminal ID of the first or second wireless communication terminal.

Preferably, the configuration for at least one of data duplication or data split comprises at least one of:
an indication for data duplication being enabled or disabled,
an indication for data split being enabled or disabled,
a data split threshold,
a split ratio,
a number of duplications
a Buffer Status reporting, BSR, report indication, or
a terminal ID for the BSR report.

Preferably, the path indication comprises at least one of:
a path ID;
a primary path or secondary path indication;
a combination of a terminal ID and a Logical Channel ID, LCID; or
a combination of a terminal ID and an RB ID.

Preferably, the aggregation assistance information to be used by aggregated terminal comprises at least one of:
a dedicated Random Access Channel, RACH, preamble; or
a cause value from the wireless communication node.

Preferably, the first wireless communication terminal transmits terminal aggregation information to the wireless communication node, and the terminal aggregation information comprises at least one of:
a terminal ID;
a terminal ID request for aggregation;
a serving cell ID of the wireless communication terminal;
a capability of the wireless communication terminal;
an indication of supported aggregation mode of the wireless communication terminal;
a number of candidate wireless communication terminals;
terminal aggregation information of the candidate wireless communication terminals; or
a terminal status report.

Preferably, the capability of the wireless communication terminal comprises at least one of: an aggregation capability, a power constraint, a band combination, a radio capability, an Aggregate Maximum Bit Rate, AMBR, or Quality of Service, QoS, parameters; wherein: the AMBR comprises at least one of: an uplink, UL, AMBR or a downlink, DL, AMBR; or the QoS parameters comprise an allowable QoS profile for Uu communication (e.g., a communication via a Uu interface) of the first wireless communication terminal.

Preferably, the terminal status report includes information of at least one of a data rate, a reliability, a Packet Delay Budget, PDB, requirement, or a channel condition.

Preferably, the first wireless communication terminal receives the aggregation configuration of the first wireless communication terminal from the wireless communication node directly or via another wireless communication terminal.

Preferably, the first wireless communication terminal transmits terminal aggregation information to the wireless communication node directly or via another wireless communication terminal.

Preferably, the first wireless communication terminal receives an indication for enabling or disabling an aggregation.

Preferably, the indication for enabling or disabling the aggregation comprises at least one of: an indication for a path to be enabled or disabled, an indication for enabling or disabling duplication, or an indication for enabling or disabling split.

Preferably, the aggregation criteria comprise at least one of a threshold of data rate, a threshold of reliability, or a threshold of PDB.

Preferably, the first wireless communication terminal performs the aggregation configuration comprises the first wireless communication terminal performs aggregation data communication comprising at least one of: a communication directly with the wireless communication node; or a communication though a second wireless communication terminal relaying data between first wireless communication terminal and the wireless communication node.

Preferably, performing the aggregation configuration comprises: transmitting, by the first wireless communication terminal to the wireless communication node, a data packet for a QoS flow mapped to an RB of a second wireless communication terminal according to a bearer mapping configuration of the aggregation configuration, via the second wireless communication terminal.

Preferably, performing the aggregation configuration comprises: transmitting, by the first wireless communication terminal to the wireless communication node, a data packet mapped to a Uu RLC channel of a second wireless communication terminal according to a bearer mapping configuration of the aggregation configuration, via the second wireless communication terminal.

Preferably, performing the aggregation configuration comprises at least one of:
establishing, by the first wireless communication terminal, an RLC entity and an associated logical channel different from an RLC entity and an associated logical channel established by a second wireless communication terminal;
allocating, by the first wireless communication terminal, a common PDCP SN according to the aggregation configuration;
performing, by the first wireless communication terminal, security and ROHC compression functions by a PDCP entity of the first wireless communication terminal separately from security and ROHC compression functions performed by a PDCP entity of the second wireless communication terminal; or
transmitting, by the first wireless communication terminal to a second wireless communication terminal, split or duplicated PDCP SDUs with the common PDCP SN.

Preferably, performing the aggregation configuration comprises at least one of:
receiving, by the first wireless communication terminal from the wireless communication node, downlink data;
performing, by the first wireless communication terminal, security and ROHC decompression functions by a PDCP entity to the downlink data separately from security and ROHC compression functions performed by a PDCP entity of a second wireless communication terminal; or
performing, by the first wireless communication terminal, PDCP reordering, duplicate detection and discard functions to the downlink data according to a common PDCP SN and the aggregation configuration.

Preferably, performing the aggregation configuration comprises at least one of:
receiving, by the first wireless communication terminal from the wireless communication node, a BSR report indication for an RB, a Logical channel, an LCG involving an aggregation; or
transmitting, by the first wireless communication terminal to the wireless communication node, a BSR report.

Preferably, performing the aggregation configuration comprises: transmitting, by the first wireless communication terminal, a BSR report comprising a PDCP data volume of a PDCP entity to a wireless communication node serving the PDCP entity.

Preferably, performing the aggregation configuration comprises at least one of:
determining, by the first wireless communication terminal, a data packet is mapped to a Uu RB of the first wireless communication terminal according to an SDAP configuration;
performing, by the first wireless communication terminal, a PDCP processing to the data packet to generate a PDCP PDU;
determining, by the first wireless communication terminal, the PDCP PDU is mapped to an RLC channel of a second wireless communication terminal according to a bearer mapping configuration; or
transmitting, by the first wireless communication terminal to the RLC channel of the second wireless communication terminal, the PDCP PDU.

Preferably, performing the aggregation configuration comprises: transmitting, by the first wireless communication terminal to RLC channels of multiple wireless communication terminals, duplicates of a PDCP PDU respectively according to the aggregation configuration.

Preferably, performing the aggregation configuration comprises: determining, by the first wireless communication terminal, wireless communication terminals to be involved for aggregated transmission in response to aggregation criteria being met.

Preferably, performing the aggregation configuration comprises: activating or deactivating, by the first wireless communication terminal, an aggregation path according to an indication for a path to be enabled or disabled.

Preferably, performing the aggregation configuration comprises at least one of:
setting up, by the first wireless communication terminal, at least one of an RB, an RLC channel, or a logical channel, making duplicates for a data packet, and delivering the data packet to the at least one of the RB, the RLC channel, or the logical channel according to an indication for enabling; or
suspend or release, by the first wireless communication terminal, the at least one of the RB, the RLC channel, or the logical channel according to an indication for disabling.

Preferably, performing the aggregation configuration comprises at least one of:
delivering, by the first wireless communication terminal, a data packet to at least one of an RB, an RLC channel, or a logical channel, based on a split ratio in response to an indication for data split being enabled; or
refraining from, by the first wireless communication terminal, splitting the data packet according to an indication for disabling.

Preferably, the terminal aggregation information comprises at least one of:
aggregation authorization information for a wireless communication terminal;
a terminal ID for one or more wireless communication terminal;
a capability of one or more wireless communication terminal; or
a supported aggregation mode.

Preferably, the aggregation authorization information comprises at least one of: an indication authorizing a wireless communication terminal for relaying data of another wireless communication terminal, or an indication authorizing a wireless communication terminal for aggregating another wireless communication terminal for delivering data of itself.

Preferably, the capability of the wireless communication terminal comprises at least one of: an aggregation capability, a power constraint, a band combination, a radio capability, an Aggregate Maximum Bit Rate, AMBR, or Quality of Service, QoS, parameters; wherein: the AMBR comprises at least one of: an uplink, UL, AMBR or a downlink, DL, AMBR; or the QoS parameters comprise an allowable QoS profile for Uu communication of the wireless communication terminal.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows a schematic diagram of a UE-to-Network relay communication according to an embodiment of the present disclosure.

FIG. 2 shows a schematic diagram of UE aggregation according to an embodiment of the present disclosure.

FIGS. 3 to 5 show a schematic diagram for allocation of UE IDs according to an embodiment of the present disclosure.

FIGS. 6 and 7 show an RB (radio bearer) level aggregation according to an embodiment of the present disclosure.

FIGS. 8 to 10 show a DAPS like aggregation according to an embodiment of the present disclosure.

FIG. 11 shows an RLC (Radio Link Control) level aggregation according to an embodiment of the present disclosure.

FIG. 12 shows a schematic diagram of a wireless communication terminal according to an embodiment of the present disclosure.

FIG. 13 shows a schematic diagram of a wireless communication node according to an embodiment of the present disclosure.

### DETAILED DESCRIPTION

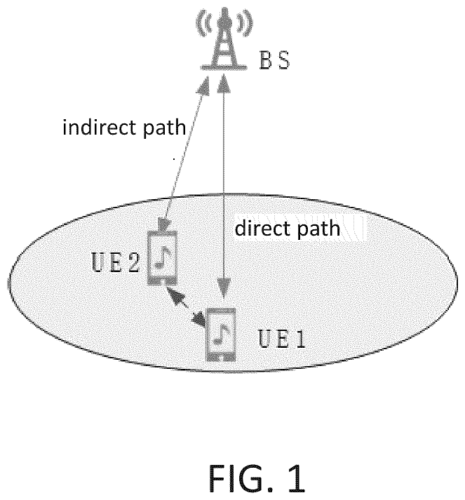

For supporting applications and services with broader ranges, a sidelink based relay communication is proposed to extend the coverage and to improve power consumption of the network. For example, the sidelink based relay communication may be applied to indoor relay communication, smart farming, smart factory and public safety services. FIG. 1 shows scenarios of applying the sidelink based relay communication which comprise user equipment (UE) (e.g. UE1 shown in FIG. 1) in an area with weak or no coverage. Under such a condition, UE1 is allowed to communicate with network (e.g. base station (BS) shown in FIG. 1) via a nearby UE2 covered by the network. As a result, the coverage of the network is extended and the capacity of the network is enlarged. In this scenario UE2 is called UE-to-Network relay and UE1 is called remote UE. On the other hand, if the remote UE is in coverage, the multi-path relay can be supported. To be specific, in coverage remote UE is connected to network via both direct (data directly transmitted between remote UE and network) and indirect (data forwarded via relay) paths, which has a potential to improve the reliability and/or robustness as well as throughput.

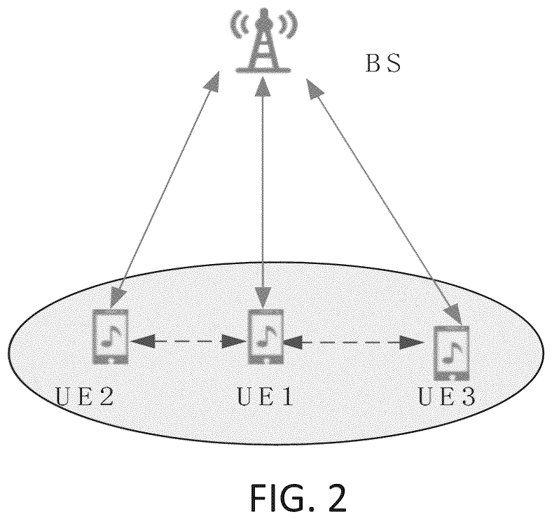

This multi-path relay solution can also be utilized for UE aggregation where a UE is connected to the network via direct path and via another UE using a non-standardized UE-UE interconnection. FIG. 2 shows scenarios of applying the UE aggregation which comprise one user equipment (UE) (e.g. UE1 shown in FIG. 1) which aggregates other UEs (e.g. UE2 and UE3 shown in FIG. 2) for its uplink (UL) or downlink (DL) transmission towards the network. The interconnection between UE1 and UE2 or between UE1 and UE3 may be based on sidelink, Wifi, Bluetooth or wireline connection. UE aggregation may provide applications high UL bitrates on 5G terminals, in cases when normal UEs are limited by UL UE transmission power to achieve required bitrate, especially at the edge of a cell. Additionally, UE aggregation can improve the reliability, stability and reduce delay of services as well.

Many aspects of the present disclosure relate to methods, systems, and devices for UE aggregation communication, such as the protocol architecture, aggregation mode and configuration.

In various embodiments of the present disclosure, in order to support the requirements of UL traffic, including data rate, latency, reliability, UE aggregation is provided. In such a case, a group of UEs are treated as one virtual UE. To be specific, a UE is connected to the network via direct path (e.g., via the UE's Uu interface between the UE and a gNB) and via another UE using a non-standardized UE-UE interconnection at the same time. To support this multi-path scenario, the following examples are described.

### Example 1

In this example, how a network identifies aggregation capable UEs and determines the potential UEs for aggregation operation are described.

Compared with SL (sidelink) U2N (UE to network) relay, it is not necessary to define the relay discovery procedure since the aggregation UEs have non-standardized UE-UE interconnections among them. The relay discovery or aggregated UE discovery can be up to UE implementation. However, the aggregation candidate UE report, which may assist the gNB (gNodeB) to determine the potential UEs for aggregation operation, may be needed.

As shown in FIG. 2, UE1 has data transmission or reception requirement and UE2 and UE3 have non-standardized UE-UE interconnection with UE1 respectively. In this case, UE1 may aggregate UE2 and UE3 for its data transmission or reception. To support the UE aggregation, the gNB should be able to get UE aggregation information of the UEs, such as UE IDs of candidate UEs for aggregation as well as UE capabilities for aggregation. To be specific, UE1 may send the UE aggregation information to the gNB. Alternatively, the gNB may get the UE aggregation information from the 5GC (5G Core network). The UE aggregation information may contain at least one of the following information:
1) the UE IDs of the candidate UEs for aggregation;
2) the serving cell IDs of the candidate UEs for aggregation (suppose the inter-gNB UE aggregation is considered);
3) the UE capabilities of the candidate UEs, such as aggregation capabilities, power constraints, band combinations, radio capabilities, AMBRs (Aggregate Maximum Bit Rates), or QoS (Quality of Service) parameters etc.; and/or
4) the supported aggregation mode, such as duplication or data split, or RLC (Radio link control) channel or DAPS (Dual Active Protocol Stack) or Separate RB (radio bearer) based aggregation.

In some embodiments, the AMBR may be one of the following: a UL AMBR and/or a DL AMBR. The QoS parameters may be an allowable QoS profile for UE's Uu communication.

The aggregation capability may include one of the following: the number of UEs allowed for aggregation transmission, the capability as one of the aggregated UEs for relaying other UE's data, and/or the capability to aggregate other UEs for its own data delivery.

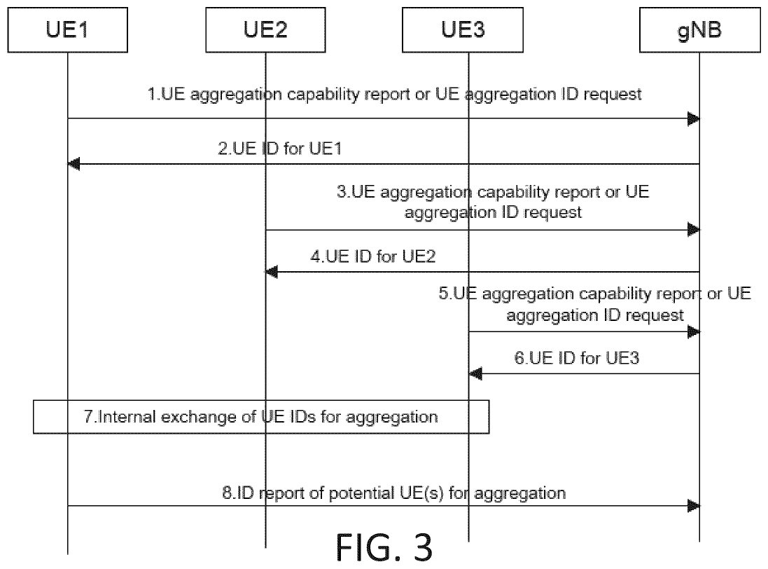

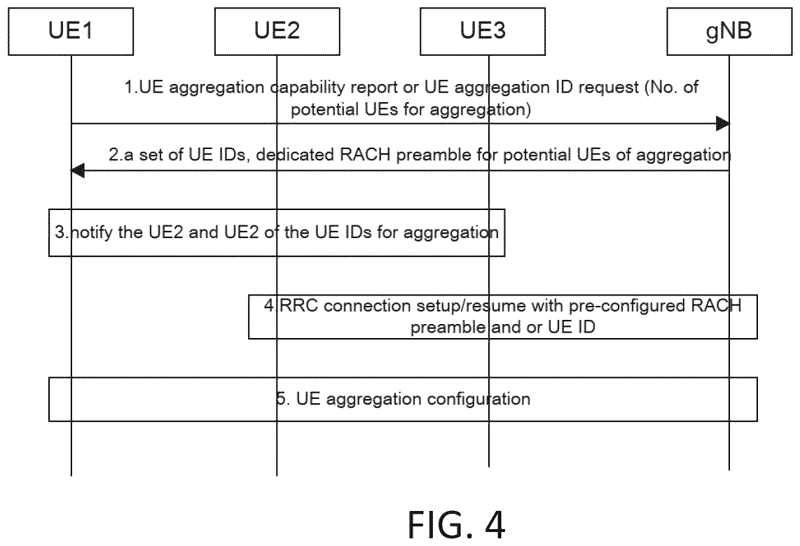

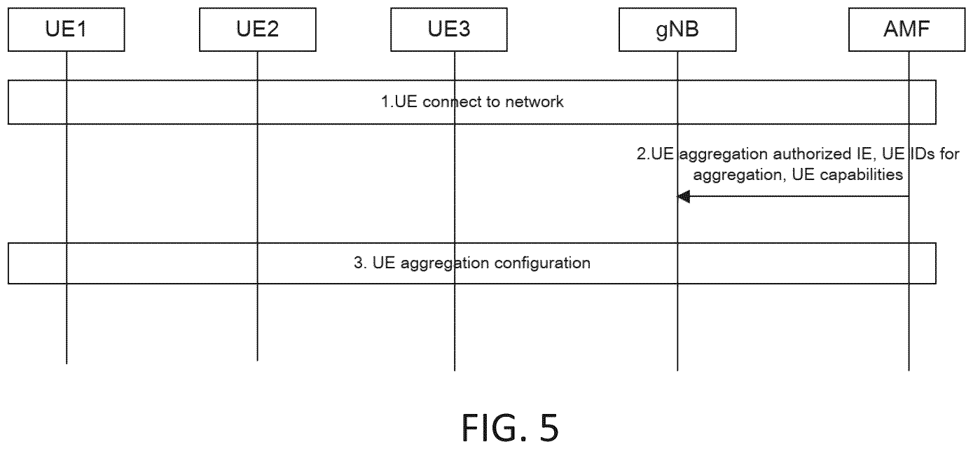

With regard to the UE IDs of the candidate UEs for aggregation, the UE ID may be C-RNTI (Cell Radio Network Temporary Identifier), S-TMSI (SAE (System Architecture Evolution) Temporary Mobile Subscriber Identity) or other newly assigned ID (referred to as aggregation ID) by the gNB. For example, UE2 and UE3 may send its C-RNTI or S-TMSI to UE1. In an embodiment, suppose a new ID assigned by the gNB is used, the following procedure may be considered:
(1) Each RRC_Connected UE gets its own ID for aggregation. As shown in FIG. 3, UE1, UE2 and UE3 which are capable of aggregation may report its aggregation capability to the gNB respectively (steps 1, 3, and 5). Then, the gNB allocates and sends the aggregation IDs to UE1, UE2 and UE3 respectively (steps 2, 4, and 6). UE1, UE2 and UE3 may negotiate the aggregation IDs via an inter-connection (step 7). When UE1 has an aggregation requirement, UE1 may report the UE IDs of UE2 and/or UE3 to the gNB (step 8). Based on UE1's report, the gNB may identify the candidate UEs for UE1's aggregation operation. On the other hand, UE1 may report the serving cell ID(s) of UE2 and/or UE3 to the gNB, which may help the gNB to determine the appropriate UE set for aggregation.
(2) The acquisition of aggregation IDs is on behalf of other UEs. Suppose UE2 and UE3 are initially in RRC_IDLE or RRC_INACTIVE state, UE1 may request the aggregation IDs for UE1, UE2 and UE3 respectively. As shown in FIG. 4, UE1 may send the UE aggregation capability information and/or the UE aggregation ID request to the gNB (step 1). The UE aggregation ID request may include the number of potential UEs for aggregation. Then, the gNB may send a set of aggregation IDs to UE1 (step 2). Additionally, the gNB may send one or more dedicated RACH (Random Access Channel) preambles and/or cause values to UE1, which may facilitate the contention free random accesses of UE2 and UE3. Upon receiving the aggregation IDs, UE1 may notify UE2 and UE3 of the aggregation IDs, dedicated RACH preambles and/or cause values (step 3). Then, UE2 and UE3 may setup the RRC connections with the pre-allocated dedicated RACH preambles, and cause values (step 4). In addition, UE2 and UE3 may report their aggregation IDs in RRC signaling to the gNB for identification of the aggregation UE set.
(3) 5GC-based aggregation information acquisition. UE1, UE2 and UE3 connect to the network, and UE1, UE2 and UE3 may have UE aggregation subscription information in the 5GC (step 1). In this case, the gNB may get the UE aggregation information from the AMF (Access and Mobility Management Function), as shown in FIG. 3 (step 2).

For example, the gNB may get the UE aggregation authorized IE (information element) from the AMF for a given UE. The UE aggregation authorization IE may include any combination of the following: an indication indicating the given UE is authorized as one of the aggregated UEs for relaying other UE's data, and/or an indication indicating the given UE is authorized to aggregate other UEs for its own data delivery.

In addition, the gNB may get the aggregation ID from the AMF. Moreover, the gNB may get the aggregation IDs for the candidate aggregation UEs for the given UE from the AMF.

Moreover, the gNB may get the UE aggregation capability information of a given UE and/or the candidate aggregation UEs from the AMF. The UE aggregation capability information may include at least one of the following information: Tx power limitation, band combination, AMBR, and/or UE radio capability.

Based on the above information, the gNB may determine whether to enable the UE aggregation transmission for a given UE and perform the corresponding UE aggregation configuration.

Suppose UE2 or UE3 is not in the RRC_Connected state, the gNB may send the paging of UE2 or UE3 to UE1 and UE1 deliver this information to UE2 or UE3. Then, UE2 or UE3 enters RRC connected state to join the UE aggregation-based data transmission and/or reception for UE1.

### Example 2

In this example, different aggregation modes and protocol architecture for the aggregation modes are presented.

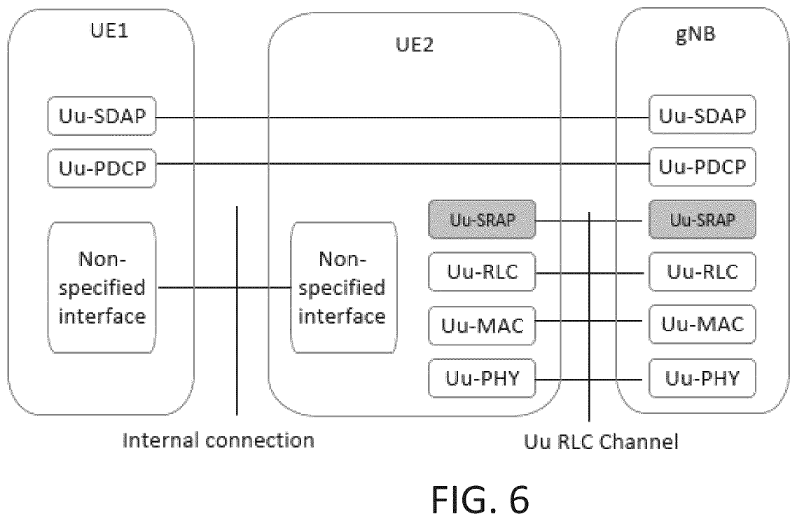

In some embodiments, UE aggregation may be used to improve the UL throughput as well as the reliability. In this example, as illustrated in FIG. 6, suppose UE1 has data traffic transmission with the gNB. UE1 and UE2 have non-standardized UE-UE connection and UE2 may assist UE1 for aggregated data traffic delivery with the gNB. Suppose the gNB decides to aggregate UE1 and UE2 for UE1's traffic with the gNB, the following protocol architecture may be considered:

### Example 2.1

### RB Level Aggregation

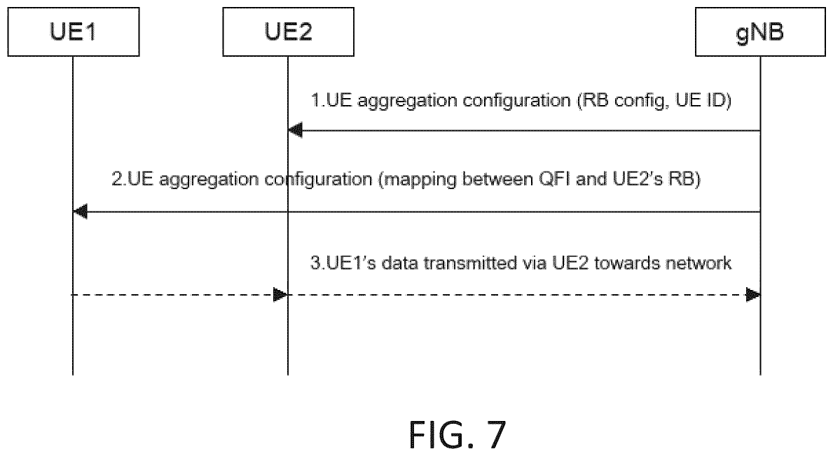

With the UP protocol stack in FIG. 6 as an example, UE1 may be configured with the QoS flows to be mapped to UE2's DRB (Data Radio Bearer). For example, as illustrated in FIG. 7, UE2 may receive a first UE aggregation configuration from the gNB, where the first UE aggregation configuration may include the RB ID and corresponding UE ID (e.g., UE1's UE ID). In addition, in step 2, UE1 may receive a second UE aggregation configuration from the gNB. The second UE aggregation configuration may include the mapping between a QFI (QOS Flow Identifier) and RB information (e.g. UE2's UE ID and RB ID of UE2's DRB). In this case, in step 3, when UE1 receives the data packet for a given QoS flow, it determines whether it is mapped to the DRB of itself or the DRB of the aggregated UE2. If it is mapped to the DRB of the aggregated UE2, UE1 delivers this packet to the aggregated UE2 via the non-standardized UE-UE connection. In addition, UE1 may send the DRB information of the data packet belongs to UE2. Upon receiving such information, UE2 transmits the packet with the corresponding DRB to the gNB via its Uu interface.

Alternatively, UE1 may receive the mapping between QFI and UE ID (e.g., UE2's ID) from the gNB for aggregation. Upon receiving the data packet associated with a given QFI, UE1 sends the packet together with the QFI and UE1's UE ID to the corresponding mapped UE2. In this case, UE2 receives from the gNB the mapping configuration between a combination of the QFI and a source aggregated UE ID and a DRB ID. UE2 maps the data packet to the DRB and sends it to the gNB. In this case, the protocol stack in FIG. 4 may be modified, such as the Uu-SDAP (Service Data Adaption Protocol) element is located at UE2 side.

Suppose a given DRB at UE2 is dedicated for UE1's data traffic aggregation, the gNB may identify the UE the data packet belongs to based on the DRB ID of UE2. On the other hand, if a given DRB at UE2 is used to deliver multiple source aggregation UE's data traffic, the source UE ID information may be needed in the PDCP (Packet Data Convergence Protocol), RLC, and/or adaptation layer subheader of the data packet.

On the other hand, for the CP (control plane), the traffic is also possible to be offloaded to other aggregation UEs. For example, UE1 may receive from the gNB the configuration of mapping between SRB (Signaling Radio Bearer) ID and aggregation ID.

In addition, UE1 may receive the SRB configuration from the gNB, which includes the aggregated UE ID to be used to deliver the SRB signaling. In this case, when UE1 has the signaling for a given SRB, it may determine whether the signaling is mapped to the SRB of itself or the aggregated UE. If it is mapped to the aggregated UE, UE1 may deliver this packet to the aggregated UE2 via the non-standardized UE-UE connection. Meanwhile, UE1 may send to UE2 the SRB ID information of the data packet belongs to UE2. Upon receiving such information, UE2 transmits the packet to the gNB with the corresponding SRB via its Uu interface.

On the other hand, the DL traffic for UE1 may also be delivered by the gNB to UE2 via the Uu interface. UE2 may identify that the traffic is for UE1 via the PDCP, RLC, and/or adaptation layer subheader of the data packet or via the UE aggregation configuration (e.g. UE2's RB ID is associated with UE1's UE ID). Then, UE2 delivers the DL packet to UE1 via the non-standardized UE-UE connection.

In some embodiments, the protocol architecture may support the RB level aggregation. The UE1 and UE2 may assign the PDCP SN (sequence number), and/or encrypt and/or decrypt the packet via its own security key, respectively. Since the PDCP SNs of UE 1 and UE2 are independent from each other, it might be hard to support the data duplication or data split among aggregated UEs.

### Example 2.2

### DAPS (Dual Active Protocol Stack) Alike Data Split or Duplication

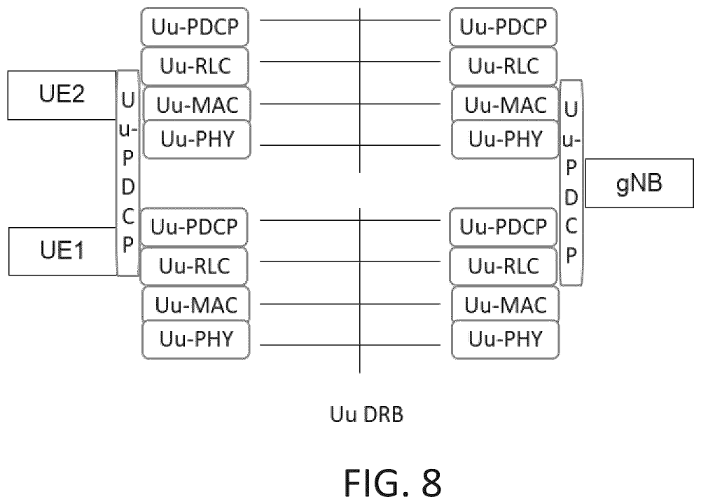

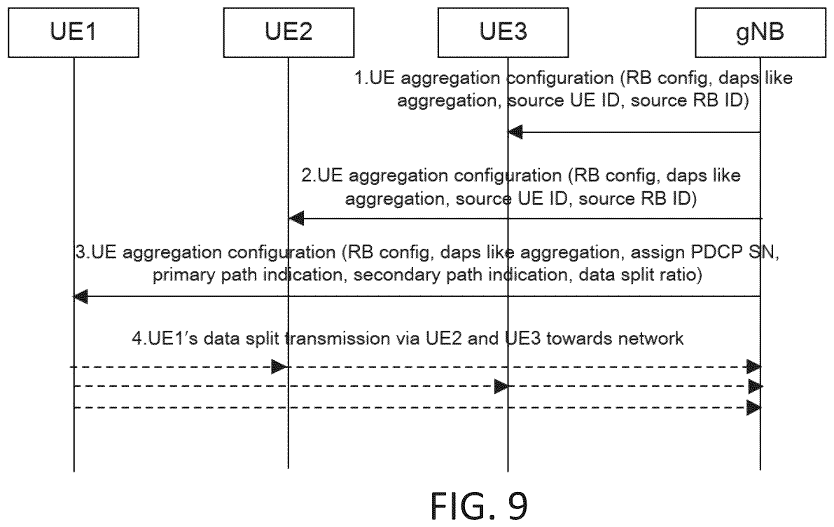

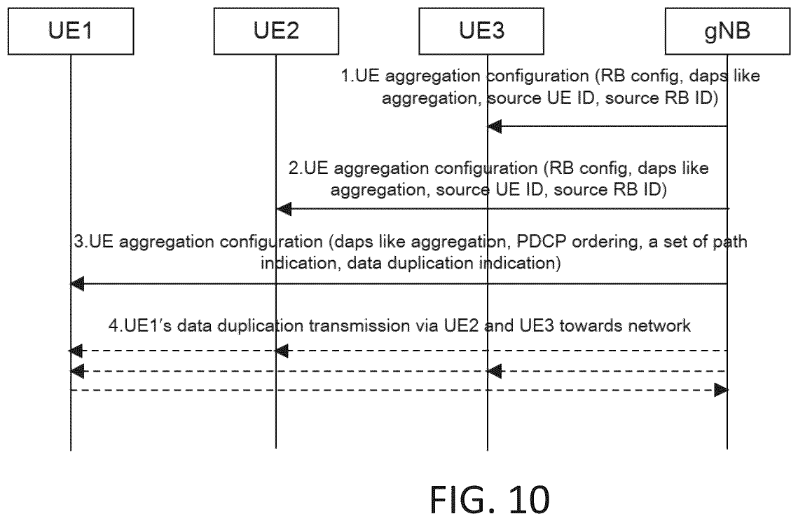

In this case, the DAPS-like data split or duplication is considered. For each RB configured with DAPS-like aggregation, both UE1 and UE2 establish the RLC (Radio Link Control) entity and associated logical channel. In addition, both UE1 and UE2 have their own PDCP entity with separate security and ROHC (Robust Header Compression) functions for the RB and associated with the RLC entities configured by UE1 and UE2 respectively. On the other hand, UE1 maintains common PDCP SN allocation and the split or duplicated PDCP SDUs are forwarded to UE2 with the common PDCP SN assigned by UE1 (as shown in FIG. 8). The UE1 and UE2 separately perform ROHC header compression and ciphering, and adding PDCP header. With regard to the gNB, the PDCP entity configured with DAPS-like aggregation maintains separate security and ROHC header decompression functions associated with each UE, while maintaining common functions for reordering, duplicate detection and discard, and PDCP SDUs (service data units) in-sequence delivery to upper layers.

In addition to the uplink, the downlink can also support the DAPS-like UE aggregation. In this case, UE1 and UE2 receives the downlink data from the gNB respectively. Then, UE1's PDCP entity and UE2's PDCP entity maintain separate security functions and ROHC header decompression functions, while maintaining common functions for reordering, duplicate detection and discard, and PDCP SDUs in-sequence delivery to UE1's upper layers.

Suppose a given RB at UE2 is dedicated for UE1's data traffic aggregation, the gNB may identify the UE the data packet belongs to based on the RB ID of UE2. On the other hand, if a given DRB of UE2 is used to deliver data traffic from multiple source aggregation UEs, it may need to include the source UE ID information in the PDCP, RLC, and/or adaptation layer subheader of the data packet.

For the DAPS-like UE aggregation, it is possible to support the data duplication or data split among aggregated UEs since the common PDCP SN is allocated for the corresponding RB. With uplink as an example, the following data duplication/split scenarios can be considered:
1) UE1 delivers source traffic, UE2 delivers duplicated traffic 1, and UE3 delivers duplicated traffic 2.
2) UE1 delivers split traffic, UE2 delivers split traffic, and UE3 delivers split traffic.
3) UE1 delivers source traffic while UE2 and UE3 jointly deliver split duplicated traffic.
4) UE1 and UE2 jointly split source traffic delivery while UE3 delivers duplicated traffic.

To support these scenarios, it is necessary to consider more flexible configurations for data split/duplication. To be specific, UE2 and/or UE3 may receive the DAPS-like aggregation configuration from the gNB, which includes any combination of the following fields: an RB configuration, a DAPS-like aggregation indication, the source UE ID and/or the RB ID of the common PDCP entity which allocates the PDCP SN.

On the other hand, UE1 may receive from the gNB the UE aggregation configuration with at least one of the following fields: an RB configuration, a DAPS-like aggregation, an indication of allocating PDCP SN, a primary path indication, a secondary path indication, a data split threshold, and/or data split ratio. If the indication of allocating PDCP SN is set to true, UE1 is responsible for the PDCP SN allocation. The primary path or secondary path indication indicates a logical channel via a combination of a UE ID, a CG (cell group) ID and an LCID (Logical Channel ID), or a DRB via a combination of a UE ID and a DRB ID.

Moreover, there may be more than one secondary path. In this case, UE1 (as illustrated in FIG. 8) may receive an additional secondary path indication from the gNB, which indicates a logical channel via a combination of UE ID, CG ID and LCID, or a DRB via a combination of UE ID and DRB ID.

For example, the primary path indicates UE1's DRB1, secondary path indicates UE2's DRB2, additional secondary path indicates UE3's DRB3. The data split ratio is 1:1:2. When there is a data packet from the upper layer and is mapped to UE1's DRB for aggregation operation, UE1's PDCP entity is responsible for the PDCP SN allocation. Then, if the total amount of PDCP data volume and RLC data volume pending for initial transmission in the primary PDCP or RLC entity and the split secondary PDCP or RLC entity is equal to or larger than data split threshold, UE1 submits the PDCP PDU (Protocol Data Unit) with allocated common PDCP SN to the primary DRB's PDCP entity or the two secondary DRB's PDCP entity based on the data split ratio. Otherwise, UE1 submits the PDCP PDU with allocated common PDCP SN to the primary DRB's PDCP entity. Then, the corresponding PDCP entity performs the data compression and/or encryption and deliver the data packet to the lower layer (e.g. RLC, MAC (Medium Access Control), and/or PHY (physical) layer) for uplink transmission.

It should be noted that one or more general path indications can be used instead of using the primary and secondary path indications. In this case, each path indication includes at least one of the following fields: a path ID, the combination of UE ID, CG ID and LCID or the combination of UE ID and DRB ID, a data split ratio, and/or a duplication number, etc.

Assume the aggregated UEs are served by the same gNB, it may only need to indicate the PDCP data volume once by one of the aggregated UEs. To be specific, the traffic originating UE can report the BSR (Buffer Status reporting). Alternatively, the gNB may indicate which UE join the aggregation should report the BSR. In this case, the UE may receive the BSR report indication for the RB, logical channel, and/or LCG (logical channel group) which involves the UE aggregation. On the other hand, if inter-gNB scenario is considered, the PDCP entity needs to calculate its own PDCP data volume and report to its serving gNB respectively.

For the DL transmission, the UEs may receive from the gNB the UE aggregation configuration, which may indicate whether the DAPS aggregation is enabled or not. Each UE2 and UE3 may receive the DAPS-like aggregation configuration from the gNB, which includes any combination of the following fields: an RB configuration, a DAPS-like aggregation indication, the source UE ID and/or the RB ID of the common PDCP entity which is responsible for the PDCP reordering and discard operation. On the other hand, UE1 may receive from the gNB with at least one of the following fields for UE aggregation configuration: an RB configuration, a DAPS-like aggregation, an indication of PDCP reception reordering and/or discard, a path indication, a data duplication indication. If the indication of PDCP reception reordering and/or discard is set to true, UE1 is responsible for the PDCP reordering and discard for the received data packet from multiple paths. The path indication may include one or more path, each includes at least one of the following fields: a path id, the combination of UE ID, a CGI D and an LCID or the combination of UE ID and DRB ID.

Suppose UE1, UE2 or UE3 receive the data packet from the gNB which is associated with UE1's DRB1 for DAPS-like aggregation, UE1, UE2 or UE3 performs the data decryption and/or decompression and then delivers the packet to UE1's common PDCP entity for DRB1 via the non-specified UE-UE interconnection. UE1's common PDCP entity for DRB1 performs the PDCP re-ordering and discard the duplicated PDCP packet and delivers the PDCP SDU to upper layer.

### Example 2.3

### PDCP Duplication/Split Based Aggregation

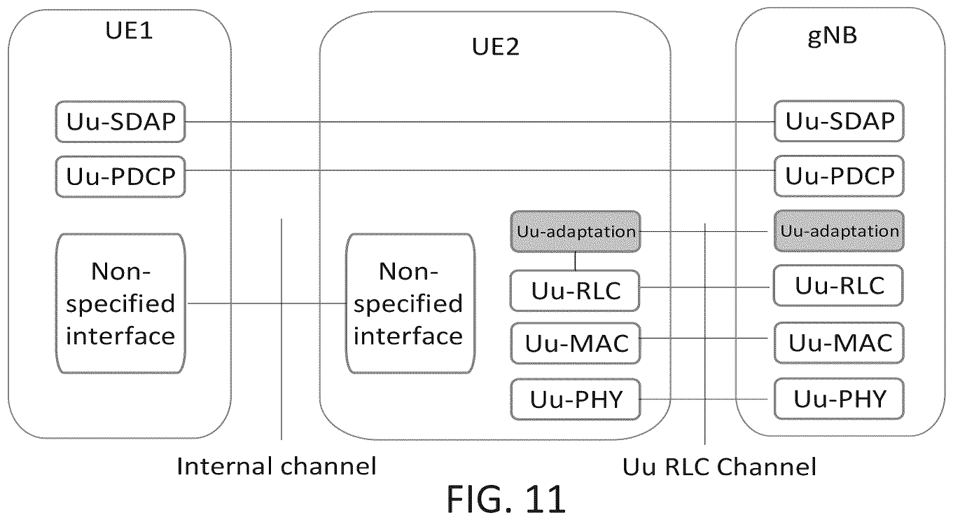

In this case, the protocol architecture is similar to the L2 (Layer 2) U2N relay. The adaptation sublayer is placed above the RLC sublayer for both CP and UP (user plane) at the Uu interface. As shown in FIG. 11, the Uu SDAP (Service Data Adaption Protocol), PDCP and RRC (Radio Resource Control) protocols are terminated between UE1 and the gNB, while adaptation, RLC, MAC and PHY protocols are terminated in the link between L2 U2N Relay UE and the gNB. Different from L2 U2N relay, the interface between UE1 and UE2 are non-specified connection instead of PC5 interface. With UE aggregation, the data split/duplication can be considered for the direct and indirect path of UE1.

The Uu adaptation sublayer supports UE1 identification information for the aggregated UL and DL traffic. That is, for the UL data packet, the identity information of UE1 Uu Radio Bearer and a UE ID 1 (for example, local Remote UE ID) are included in the Uu adaptation header in order for the gNB to correlate the received packets for the specific PDCP entity associated with the right Uu Radio Bearer of the traffic originating UE1. With regard to the DL data packet, the identity information of UE1's Uu Radio Bearer and UE ID 1 (for example, a local Remote UE ID) are included into the Uu adaptation header by the gNB at DL data packet in order for UE2 to identify the received packets for UE1 Uu Radio Bearer and then deliver it to UE1 via the non-specified interface.

For the bearer mapping, the following scenarios can be considered:
(1) For UL mapping: UE1 or UE2 may receive the bearer mapping configuration from the gNB, which includes the mapping between UE1's Uu RB (identified by UE1's UE ID and RB ID) and UE2's Uu RLC channel (identified by the combination of UE2's UE ID, CG ID and LCID, or the combination of UE2's UE ID and RLC channel ID). On the other hand, UE1 may receive the PDCP configuration from the gNB for UE1's RB, which may include at least one of the following fields for the data split/duplication purpose: information of the primary path, information of the secondary path, an indication of duplication enabled, a split threshold, and/or a split ratio. Alternatively, information of the primary path, information of the secondary path, an indication of duplication enabled, a split threshold, and/or a split ratio may be configured within the bearer mapping configuration.

When UE1 has the data packet, UE1 may map the data packet to UE1's Uu DRB1 according to the SDAP configuration. After the PDCP processing, the PDCP PDU is mapped to UE2's RLC channel 1 based on the bearer mapping configuration. Then, UE1 delivers the PDCP PDU to UE2's RLC channel1 for further uplink transmission via UE2. Moreover, if the data duplication is enabled and multiple paths are configured, UE1 may deliver the multiple PDCP PDU duplicates to the RLC channel of UE1, UE2 and/or UE3 respectively for UL transmission.

(2) For DL mapping, it is not necessary to configure UE2 with the mapping between Uu RLC channel and UE1's RB since the Uu adaptation header already include UE1's RB information which can be used for the bearer mapping purpose. UE1 or UE2 may receive information of the primary path, information of the secondary path, and corresponding Uu RLC channel or logical channel configuration along with the PDCP configuration or the bearer mapping configuration.

On the other hand, UE1's aggregation ID can reuse the local UE ID. It should be noted that the local UE ID of UE1 can be requested by UE1 itself instead of by UE2 as in L2 U2N scenario. In this case, UE1 may be assigned with the aggregation ID (e.g., local UE ID) upon the gNB receives the UE aggregation capability/request/report information from UE1 via the direct path. Different from L2 U2N relay, UE2 also may be assigned a local ID for aggregation purpose.

### Example 3

In this section, how to select the appropriate number of aggregated UEs to form a virtual UE for a specific service transmission is discussed. The criteria for UE aggregation may be dependent on the data rate of traffic originating UE, reliability and latency requirement of corresponding service, channel condition of UEs, UE's radio capability (power, band combination), the number of available UEs for aggregation. The aggregation may be initiated by the gNB or traffic originating UE. The details in various embodiments are described below.

### (1) gNB Initiated UE Aggregation:

The gNB gets the UE aggregation capability information (from UE or from the AMF), QOS information (based on the PDU session resource request/modification information from AMF), channel condition (based on UE measurement report), and makes the UE aggregation decision. To be specific, the gNB determines which and how many UEs should be involved for the aggregated transmission of traffic originating UE, the aggregation mode, the workload split, whether duplication should be enabled etc. Then, the gNB configures these UEs correspondingly. In an embodiment, the gNB may configure the involved UE one by one via RRC signaling. It is also possible to send the UE aggregation configuration corresponding to multiple UEs to only one involved UE. In this case, this UE may receive multiple UE aggregation configurations with corresponding UE IDs. Then, this UE may deliver the other UE's relevant configuration to other UE via non-specified UE-UE interconnection.

### (2) UE Initiated Aggregation:

In this case, the gNB may send the UE aggregation criteria to a UE, such as the threshold for data rate, reliability, etc. When the traffic initiating UE detects the UE aggregation criteria is met, it may determine which aggregation capable UE should be involved for aggregated transmission. Then, the gNB may allocate the RLC channel for these involved aggregated UEs. To accelerate the access of aggregated UE, the involved aggregated UEs may skip the access control, use dedicated random access preamble configured previously by the gNB via the traffic originating UE, or use special cause value for RRC connection setup and/or resume.

In some situations, the gNB initiated aggregation might be more appropriate since the UE needs to enter RRC connected state for the U2N traffic transmission and the gNB need to configure the RLC channel and data split/duplication rules. In addition, when the data rate, a reliability, a PDB (Packet Delay Budget) requirement, or a channel condition changes, the gNB may reconfigure the aggregated paths and/or the split ratio, and/or the gNB may enable or disable the duplication.

On the other hand, the multi-path for UE aggregation may be activated/deactivated based on the UE channel condition, traffic load, and the packet error rate at the receiver side. The UE aggregation may be in the form of data duplication, data split among multiple UEs. RRC signaling and MAC CE may be used for the UE aggregation path activation/deactivation. Suppose MAC CE is used, the path ID may be included to indicate the activation/deactivation. On the other hand, the MAC CE may be transmitted to any UEs within the aggregation. In this case, the path ID, a combination of UE ID, CG ID, and LCID, and/or a combination of UE ID and DRB ID can also be used to indicate which path is activated/deactivated.

The number of UEs involved in the aggregation may change. For example, more UEs may be eligible for the aggregation due to the change of channel or traffic load condition. It also may occur that the number of UEs is reduced, for example, a UE detects RLF (Radio Link Failure) or channel deterioration or is not willing to join the aggregation. In this case, the traffic/aggregation originating UE may report the measurement and/or capability of all the potential UEs for aggregation. Upon receiving such a report, the gNB may send at least one of the following reconfigurations to UE:
(1) enable/disable duplication: if duplication is enabled, setup the corresponding DRB/RLC channel/logical channel, make duplicates for the data packet to be transmitted, and then deliver the packet to the corresponding DRB/logical channel. On the other hand, if duplication is disabled: suspend or release corresponding RB/RLC channel/logical channel; and or
(2) enable/disable data split: deliver the packet based on the split rule to the corresponding DRB/RLC channel/logical channel.

With regard to the mode switch, it involves the PDCP/RLC entity release/setup, it can be reconfigured via RRC signaling by the gNB.

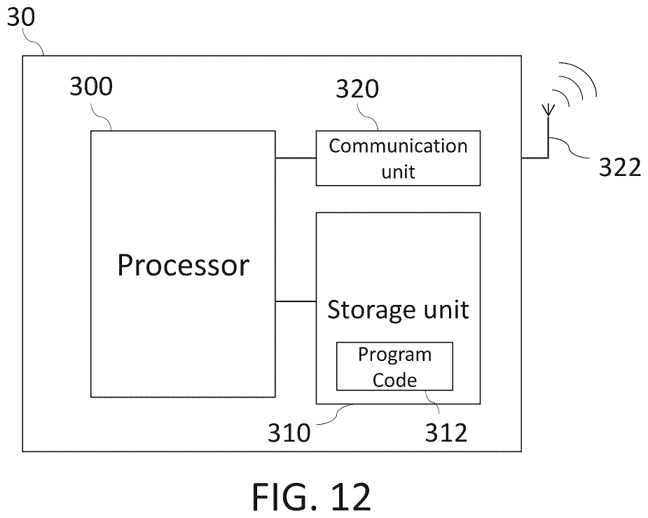

FIG. 12 relates to a schematic diagram of a wireless communication terminal 30 (e.g., a terminal node or a terminal device) according to an embodiment of the present disclosure. The wireless communication terminal 30 may be a user equipment (UE), a remote UE, a relay UE, a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the remote UE or the relay UE described above. In some embodiments, the processor 300 and the communication unit 320 collaboratively perform the operations described above. For example, the processor 300 performs operations and transmit or receive signals, message, and/or information through the communication unit 320.

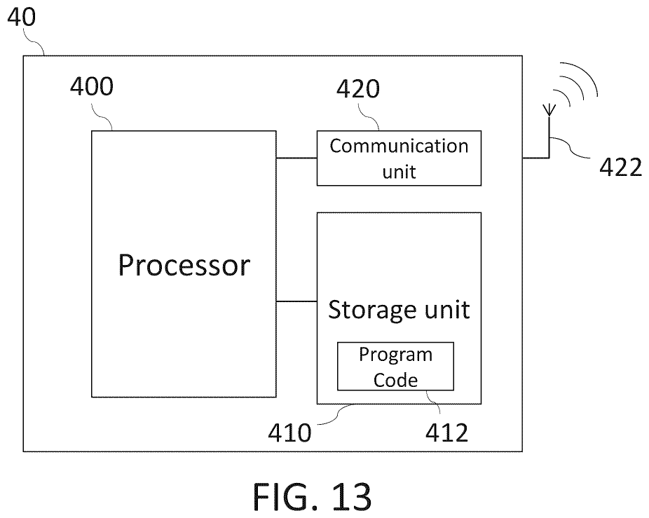

FIG. 13 relates to a schematic diagram of a wireless communication node 40 (e.g., a network device) according to an embodiment of the present disclosure. The wireless communication node 40 may be a satellite, a base station (BS), a gNB, a gNB-DU, a gNB-CU, a network entity, a Mobility Management Entity (MME), Serving Gateway (S-GW), Packet Data Network (PDN) Gateway (P-GW), a radio access network (RAN), a next generation RAN (NG-RAN), a data network, a core network or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the gNB1, the gNB2, or the CU described above. In some embodiments, the processor 400 and the communication unit 420 collaboratively perform the operations described above. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a remote UE). In an embodiment, the wireless communication terminal may be implemented by using the wireless communication terminal 30 described above, but is not limited thereto.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A wireless communication method comprising:
receiving, by a first wireless communication terminal from a wireless communication node, an aggregation configuration; and
performing, by the first wireless communication terminal, the aggregation configuration.

2. The wireless communication method of claim 1, wherein the aggregation configuration comprises at least one of:
an aggregation index;
one or more terminal identifiers, IDs, for aggregation;
an aggregation mode;
a bearer mapping configuration;
a configuration for at least one of data duplication or data split;
a path indication;
aggregation assistance information to be used by aggregated terminals; or
aggregation criteria.

3. The wireless communication method of claim 2, wherein:
the terminal ID can be at least one of the following:
a Cell Radio Network Temporary Identifier, C-RNTI,
a System Architecture Evolution Temporary Mobile Subscriber Identity, S-TMSI, or
an aggregation ID received from the wireless communication node; and/or
the aggregation mode configuration comprises at least one of:
a radio bearer, RB, level aggregation;
a Dual Active Protocol Stack, DAPS, like aggregation; or
a Radio Link Control, RLC, channel level aggregation.

4. The wireless communication method of claim 2, wherein the bearer mapping configuration comprises at least one of:
a mapping between a Radio Bearer, RB, of the first wireless communication terminal and an RB of the first or a second wireless communication terminal;
a mapping between a Radio Bearer, RB, of the first wireless communication terminal and a terminal ID for aggregation of the first or second wireless communication terminal;
a mapping between a QoS Flow Identifier, QFI, of the first wireless communication terminal and a Radio Bearer, RB, of the first or second wireless communication terminal;
a mapping between a QoS Flow Identifier, QFI, of the first wireless communication terminal and a terminal ID for aggregation of the first or second wireless communication terminal; or
a mapping between an RB of the first wireless communication terminal and a Uu RLC channel of a second wireless communication terminal, wherein the Uu RLC channel of the second wireless communication terminal is identified by a terminal ID, a Logical Channel ID, LCID or an RLC channel ID.

5. The wireless communication method of claim 2, wherein the bearer mapping configuration comprises at least one of:
an indication indicating the first or second wireless communication terminal allocating a common Packet Data Convergence Protocol, PDCP, sequence number, SN;
an indication indicating the first or second wireless communication terminal responsible for PDCP reordering and discard functions;
an RB of the first or second wireless communication terminal of the common PDCP entity which allocates the PDCP SN;
an RB of the first or second wireless communication terminal of the common PDCP entity which is responsible for PDCP reordering and discard functions; or
an RB of the first or second wireless communication terminals participating in the PDCP encryption or decryption, compression or de-compression processing,
wherein the RB of the first or second wireless communication terminal is identified via the RB ID and or the terminal ID of the first or second wireless communication terminal.

6. The wireless communication method of claim 2, wherein:
the configuration for at least one of data duplication or data split comprises at least one of:
an indication for data duplication being enabled or disabled,
an indication for data split being enabled or disabled,
a data split threshold,
a split ratio,
a number of duplications
a Buffer Status reporting, BSR, report indication, or
a terminal ID for the BSR report.

7. The wireless communication method of claim 2, wherein:
the path indication comprises at least one of:
a path ID;
a primary path or secondary path indication;
a combination of a terminal ID, and a Logical Channel ID, LCID; or
a combination of a terminal ID and an RB ID; and/or
the aggregation assistance information to be used by aggregated terminal comprises at least one of:
a dedicated Random Access Channel, RACH, preamble; or
a cause value from the wireless communication node.

8. The wireless communication method of claim 1, wherein the first wireless communication terminal transmits terminal aggregation information to the wireless communication node, and the terminal aggregation information comprises at least one of:
a terminal ID;
a terminal ID request for aggregation;
a serving cell ID of the wireless communication terminal;
a capability of the wireless communication terminal;
an indication of supported aggregation mode of the wireless communication terminal;
a number of candidate wireless communication terminals;
terminal aggregation information of the candidate wireless communication terminals; or
a terminal status report.

9. The wireless communication method of claim 8, wherein the capability of the wireless communication terminal comprises at least one of: an aggregation capability, a power constraint, a band combination, a radio capability, an Aggregate Maximum Bit Rate, AMBR, or Quality of Service, QoS, parameters; wherein:
the AMBR comprises at least one of: an uplink, UL, AMBR or a downlink, DL, AMBR; or
the QoS parameters comprise an allowable QoS profile for Uu communication of the first wireless communication terminal,
wherein the terminal status report includes information of at least one of a data rate, a reliability, a Packet Delay Budget, PDB, requirement, or a channel condition.

10. The wireless communication method of claim 1, wherein:
the first wireless communication terminal receives the aggregation configuration of the first wireless communication terminal from the wireless communication node directly or via another wireless communication terminal;
the first wireless communication terminal transmits terminal aggregation information to the wireless communication node directly or via another wireless communication terminal;
the first wireless communication terminal receives an indication for enabling or disabling an aggregation, wherein the indication for enabling or disabling the aggregation comprises at least one of: an indication for a path to be enabled or disabled, an indication for enabling or disabling duplication, or an indication for enabling or disabling split.

11. The wireless communication method of claim 2, wherein:
the aggregation criteria comprise at least one of a threshold of data rate, a threshold of reliability, or a threshold of PDB; and/or
the first wireless communication terminal performs the aggregation configuration comprises the first wireless communication terminal performs aggregation data communication comprising at least one of:
a communication directly with the wireless communication node; or
a communication though a second wireless communication terminal relaying data between first wireless communication terminal and the wireless communication node.

12. The wireless communication method of claim 1, wherein performing the aggregation configuration comprises at least one of:
transmitting, by the first wireless communication terminal to the wireless communication node, a data packet for a QoS flow mapped to an RB of a second wireless communication terminal according to a bearer mapping configuration of the aggregation configuration, via the second wireless communication terminal; or
transmitting, by the first wireless communication terminal to the wireless communication node, a data packet mapped to a Uu RLC channel of a second wireless communication terminal according to a bearer mapping configuration of the aggregation configuration, via the second wireless communication terminal.

13. The wireless communication method of claim 1, wherein performing the aggregation configuration comprises at least one of:
establishing, by the first wireless communication terminal, an RLC entity and an associated logical channel different from an RLC entity and an associated logical channel established by a second wireless communication terminal;
allocating, by the first wireless communication terminal, a common PDCP SN according to the aggregation configuration;
performing, by the first wireless communication terminal, security and ROHC compression functions by a PDCP entity of the first wireless communication terminal separately from security and ROHC compression functions performed by a PDCP entity of the second wireless communication terminal;
transmitting, by the first wireless communication terminal to a second wireless communication terminal, split or duplicated PDCP SDUs with the common PDCP SN.

14. The wireless communication method of claim 1, wherein performing the aggregation configuration comprises at least one of:
receiving, by the first wireless communication terminal from the wireless communication node, downlink data;
performing, by the first wireless communication terminal, security and ROHC decompression functions by a PDCP entity to the downlink data separately from security and ROHC compression functions performed by a PDCP entity of a second wireless communication terminal;
performing, by the first wireless communication terminal, PDCP reordering, duplicate detection and discard functions to the downlink data according to a common PDCP SN and the aggregation configuration;
receiving, by the first wireless communication terminal from the wireless communication node, a BSR report indication for an RB, a Logical channel, an LCG involving an aggregation;
transmitting, by the first wireless communication terminal to the wireless communication node, a BSR report; or
transmitting, by the first wireless communication terminal, a BSR report comprising a PDCP data volume of a PDCP entity to a wireless communication node serving the PDCP entity.

15. The wireless communication method of claim 1, wherein performing the aggregation configuration comprises at least one of:
determining, by the first wireless communication terminal, a data packet is mapped to a Uu RB of the first wireless communication terminal according to an SDAP configuration;
performing, by the first wireless communication terminal, a PDCP processing to the data packet to generate a PDCP PDU;
determining, by the first wireless communication terminal, the PDCP PDU is mapped to an RLC channel of a second wireless communication terminal according to a bearer mapping configuration;
transmitting, by the first wireless communication terminal to the RLC channel of the second wireless communication terminal, the PDCP PDU;
transmitting, by the first wireless communication terminal to RLC channels of multiple wireless communication terminals, duplicates of a PDCP PDU respectively according to the aggregation configuration;
determining, by the first wireless communication terminal, wireless communication terminals to be involved for aggregated transmission in response to aggregation criteria being met; or
activating or deactivating, by the first wireless communication terminal, an aggregation path according to an indication for a path to be enabled or disabled.

16. The wireless communication method of claim 1, wherein performing the aggregation configuration comprises at least one of:
setting up, by the first wireless communication terminal, at least one of an RB, an RLC channel, or a logical channel, making duplicates for a data packet, and delivering the data packet to the at least one of the RB, the RLC channel, or the logical channel according to an indication for enabling;
suspend or release, by the first wireless communication terminal, the at least one of the RB, the RLC channel, or the logical channel according to an indication for disabling;
delivering, by the first wireless communication terminal, a data packet to at least one of an RB, an RLC channel, or a logical channel, based on a split ratio in response to an indication for data split being enabled; or
refraining from, by the first wireless communication terminal, splitting the data packet according to an indication for disabling.

17. A wireless communication method comprising:
receiving, by a wireless communication node from a core network, terminal aggregation information; and
performing, by the wireless communication node, an aggregation configuration.

18. The wireless communication method of claim 17, wherein the terminal aggregation information comprises at least one of:
aggregation authorization information for a wireless communication terminal;
a terminal ID for one or more wireless communication terminal;
a capability of one or more wireless communication terminal; or
a supported aggregation mode.

19. The wireless communication method of claim 18, wherein the aggregation authorization information comprises at least one of: an indication authorizing a wireless communication terminal for relaying data of another wireless communication terminal, or an indication authorizing a wireless communication terminal for aggregating another wireless communication terminal for delivering data of itself,
wherein the capability of the wireless communication terminal comprises at least one of: an aggregation capability, a power constraint, a band combination, a radio capability, an Aggregate Maximum Bit Rate, AMBR, or Quality of Service, QoS, parameters; wherein:
the AMBR comprises at least one of: an uplink, UL, AMBR or a downlink, DL, AMBR; or
the QoS parameters comprise an allowable QoS profile for Uu communication of the wireless communication terminal.

20. A wireless communication terminal, comprising:
a communication unit; and
at least one processor configured to: receive, from a wireless communication node, an aggregation configuration; and perform the aggregation configuration.
